(19) United States
(12) Patent Application Publication
(10) Pub. No.: US 2010/0296852 A1
(43) Pub. Date: Nov. 25, 2010

(54) Sheet feeding unit and electrophotographic image forming apparatus

(75) Inventor: Hideto Higaki, Yokohama-shi (JP)

Correspondence Address: Harness, Dickey & Pierce P.L.C., P.O. Box 8910, Reston, VA, 20195, US

(73) Assignee: Ricoh Company, Ltd.

(21) Appl. No.: 12/801,015

(22) Filed: May 17, 2010

(30) Foreign Application Priority Data
May 20, 2009 (JP) 2009-121544
May 6, 2010 (JP) 2010-106429

(51) Int. Cl. G03G 15/00

(52) U.S. Cl. 399/390

(57) ABSTRACT

A sheet feeding unit that can be incorporated in an image forming apparatus includes an endless belt and a charging member. The charging member charges the endless belt with an alternating voltage to attract a sheet to separate from multiple sheets and feed the sheet, and has an electrode contacting the endless belt at an angle thereto and between which a nip is formed. The endless belt and an interior surface of the charging member define a space across which electric discharge is performed to charge an outer layer of the endless belt. A distance of the gap and a length of the nip in the sheet conveyance direction define a basic charging region. The distance of the basic charging region is smaller than a distance of a unit charging region where the electric charge of identical polarity is held on the endless belt.

### CROSS-REFERENCE TO RELATED APPLICATIONS

The present patent application claims priority pursuant to 35 U.S.C. §119 from Japanese Patent Application No. 2009-121544, filed on May 20, 2009 in the Japan Patent Office, and Japanese Patent Application No. 2010-106429, filed on May 6, 2010 in the Japan Patent Office, which are hereby incorporated by reference herein in their entirety.

### BACKGROUND OF THE INVENTION

1. Field of the Invention

Exemplary embodiments of the present patent application relate to a sheet feeding unit and an electrophotographic image forming apparatus incorporating the sheet feeding unit, and more particularly, to a sheet feeding unit that electrostatically attracts a sheet of a recording medium to an endless belt member for separating and feeding the sheet therefrom, and an electrophotographic image forming apparatus including the sheet feeding unit.

2. Discussion of the Related Art

Related-art image forming apparatuses, such as electrophotographic copiers, facsimile machines, printers, or multifunction printers having at least one of copying, printing, scanning, and facsimile functions, typically form an image on a sheet of recording media according to image data. Thus, for example, a sheet feeding unit loads a plurality of sheets and feeds the plurality of sheets one by one toward an image forming device. The image forming device forms an image on a sheet supplied from the sheet feeding unit.

The sheet feeding unit often employs a friction feed method using a pickup member. Examples of the pickup member include a roller and a belt each including a material having a larger coefficient of friction such as rubber.

One problem with such an arrangement using the friction feed method is that, although a configuration of the sheet feeding unit can be simplified, the pick-up member may need to be pressed against the surface of an uppermost sheet with a biasing member such as a spring or the like to obtain a large frictional force. Because the coefficient of friction at the surface of the pick-up member having a larger coefficient of friction such as rubber may deteriorate over time and according to environmental factors, the friction feed method cannot stably provide a higher ability to reliably feed the sheet.

Further, in recent years a wider variety of recording media including special paper, such as coated paper and label paper, have come to be used as well as plain paper in the image forming apparatuses by diverse users, and it is expected that the number of different types of recording media demanded by users will further increase in the future. With recording media having a substantially small coefficient of friction, sheets providing friction varying depending on temperature, or sheets absorbing moisture and adhering to each other, the pickup-up member of the sheet feeding unit may not separate the uppermost sheet from other sheets properly with only the friction feed method.

One possible solution to the above-described problems is to employ an air suction method in which negative pressure is generated by air suction to suction and convey the recording media. However, although providing a more reliable ability to feed the recording media compared to the friction feed method, the air suction method may be noisy and cause an increase in size and costs of the sheet feeding unit. Consequently, the air suction method is not practical for image forming apparatuses installed in an office or the like.

Another approach is a so-called sheet separation method, in which air is blown from a direction opposite an edge surface of a sheet moving direction of a stack of a plurality of sheets to separate an uppermost sheet from the other with a friction roller. However, this sheet separation method may also be noisy and cause an increase in size and costs of the sheet feeding unit.

As yet another approach, an electrostatic sheet feed method to separate and feed a sheet electrostatically has been proposed.

The electrostatic sheet feed method is employed in a sheet feeding unit including an endless dielectric belt member and a charging member for charging and discharging the surface of the endless dielectric belt.

The endless dielectric belt member that rotates in a sheet feed direction contacts a top surface of a stack of sheets, and the charging member applies alternating charges (that is, electrical charges of alternating polarity) to the surface of the endless dielectric belt member. The charging member performs both a charging operation to form an alternating charge pattern on the surface of the endless dielectric belt member and a discharging operation to discharge or remove the charge from the surface of the endless dielectric belt member. Application of electric charge to the endless dielectric belt member to contact the endless dielectric belt member to the sheet increases the electric potential of the sheet and causes oppositely polarized electric charges to generate a force of attraction. This action can separate the uppermost sheet from the stack of sheets and feed the uppermost sheet in a sheet conveyance direction.

As still yet another approach, a comb-toothed set of positive and negative electrodes are arranged on an endless dielectric belt member in such a manner that the positive and negative electrodes are sequentially alternating across predetermined gaps on the endless dielectric belt member in a direction of rotation of the endless dielectric belt member. A positive voltage is applied to the positive electrode and a negative voltage is applied to the negative electrode to generate an electric field on the endless dielectric belt member so that the endless dielectric belt member applies a force of attraction to the uppermost sheet to attract the uppermost sheet, thereby reliably separating the uppermost sheet from the stack of sheets and feeding the uppermost sheet in the sheet conveyance direction.

However, with the method in which an electric field formed on the endless belt member exerts a force of attraction on the sheet, an attraction force sufficient to separate and feed the sheets due to environmental conditions and resistivity of the sheets, and/or elapse of a predetermined period of time after the endless belt member contacts the sheet, the force of attraction caused by the electric field may be generated to a plurality of loaded sheets as well as the uppermost sheet.

Conversely, when a sufficient force of attraction cannot be obtained, sheets cannot be fed and conveyed properly. If the endless belt member is rotated in the sheet conveyance direction while the force of attraction is still exerted on the plurality of sheets, two or more sheets are fed mistakenly, and proper sheet feeding cannot be performed reliably.

There are some known techniques to address the above-described drawbacks.

One technique, herein referred to as Technique 1, is that the physical properties of a target sheet are measured to control the amount of charge to apply to the endless dielectric belt member, a distance or interval between electric charges on the endless dielectric belt member, and a period of time for attracting the sheet according to the measured value. With this technique, the force of attraction exerted on any subsequent sheet can be minimized.

Another technique, or Technique 2, provides a movable blocking member that can stop and move in a direction opposite the sheet conveyance direction to the endless dielectric belt member with the sheet conveyance path interposed therebetween.

Yet another technique, or Technique 3, involves taking a predetermine period of time from when the endless dielectric belt member contacts a sheet to when the sheet separates from a stack of sheets before performing the sheet feeding operation.

However, in Technique 1, the necessity of measurement of the physical property of a target sheet after separation from a stack of sheets makes it impossible to control for the first sheet. Further, the technique is inapplicable where sheets having different physical properties are accommodated in the same cassette.

Further, as described in Technique 2, the blocking member is pressed against the endless belt member, which generates the electric field to exert the force of attraction on the leading edge of several sheets placed below the uppermost sheet. This makes it difficult for the blocking member to reliably separate the uppermost sheet from these sheets, considering a wide range of conditions.

Further, Technique 3 requires a substantially long contact period of time, and it is likely to decrease productivity of the sheet feeding unit, resulting in lack of merchantability.

In Technique 3, in which the long contact time of the endless dielectric belt member to the uppermost sheet is required, it is known based on the Maxwell stress per period of time for each sheet that, the smaller the interval between a positive charge and a negative charge to the endless belt member the faster the force of attraction exerted on the uppermost sheet of the stack of sheets reaches the maximum value and the faster the force of attraction exerted on any subsequent sheets reaches the minimum value.

However, if a charging roller is used as a charging electrode to charge the surface of the endless belt member, the intervals or charging pitches between the alternating charges including positive charge and negative charge cannot be decreased, which is disadvantageous for the following reason.

Referring to FIG. 1, a related-art sheet feeding device SFD is explained.

As illustrated in FIG. 1, the related-art sheet feeding device SFD includes a charging roller 1 serving as a charging electrode and an endless belt 2. A contact portion or a nip N formed between the charging roller 1 and the endless belt 2 has a certain nip length. The related-art sheet feeding device SFD further includes two small gaps, which are a small gap gap Gu formed upstream and a small gap Gd formed downstream from the nip of the charging roller 1 and the endless belt 2 for charging a surface 2a of the endless belt 2. Specifically, one of the two small gaps G is located at a position immediately before the charging roller 1 contacts the endless belt 2 and the other is located at a position immediately after the charging roller 1 separates from the endless belt 2. When the alternating voltage is applied to the charging roller 1, the surface 2a of the endless belt 2 is charged alternatively at each predetermined unit charging region W on the surface 2a of the endless belt 2, as illustrated with models of positive and negative charges on the surface 2a of the endless belt 2 in FIG. 1.

To make a basic charging region H determined according to the small gaps Gu and Gd and the length of the nip N to be greater than the length of the unit charging region W as illustrated in FIG. 1, a diameter DM of the charging roller 1 is greater than the length of the unit charging region W. The charging roller 1 has a middle resistance or a low resistance in the nip N. In this case, if the charging roller 1 applies an electric potential that has a polarity opposite the electric charge to the endless belt member 2 (e.g., a voltage having a positive polarity is applied to the charging roller 1 and a voltage having a negative polarity is applied in the unit charging region W within the nip N), the electric charge on the endless belt member 2 can move as illustrated in an area A of FIG. 1.

Further, even in a state of contact it is likely that there are both contact and non-contact portions between the charging roller 1 and the endless belt 2 at the micro level. For this reason, when a potential having a negative polarity is applied to the charging roller 1, electric discharge occurs to charge the endless belt 2 with the negative polarity as shown in the area A in a unit charging region W in FIG. 1. Consequently, it is likely that the charge applied to an area B in an adjacent unit charging region W located downstream from the nip N in the rotation direction D1 of the endless belt 2 as shown in FIG. 1 will be weaker.

Further, in the small gap Gu formed immediately before the charging roller 1 contacts the endless belt 2 and the small gap Gd formed immediately after the charging roller 1 separates from the endless belt 2, electrical discharging occurs at the small gaps Gu and Gd when switching the voltages between a positive polarity and a negative polarity for applying the alternating charge.

Therefore, when a voltage having a positive polarity is applied to the charging roller 1, the unit charging region W having the area A at the small gap Gu formed upstream from the nip of the charging roller 1 and the endless belt 2 in the belt rotation direction D1 is positively charged. Unlike the unit charging region W having the area A, the unit charging region W having the area B at the small gap Gd formed downstream from the nip of the charging roller 1 and the endless belt 2 in the belt rotation direction D1 is also positively charged even though the unit charging region W having the area B had been negatively charged.

As a result, minute alternating charges cannot be provided, which cannot obtain the necessary force of attraction for attracting the sheets onto the endless belt member 2.

### SUMMARY OF THE INVENTION

Exemplary aspects of the present patent application have been made in view of the above-described circumstances, and provide a sheet feeding unit that can make a charging pitch smaller and perform feeding operations stably with various types of sheets loaded in a even when the environmental condition changes over time and can be highly reliable in separating and feeding sheets one by one in a fast and robust manner.

Other example aspects of the present patent application can provide an electrophotographic image forming apparatus incorporating the above-described sheet feeding unit.

In one exemplary embodiment, the sheet feeding unit includes an endless belt and a charging member. The endless belt of multilayer construction includes an outer layer formed by a dielectric material. The charging member includes an electrode disposed in angled contact with the endless belt to charge the outer layer of the endless belt with an alternating voltage. The charging member generates a force of attraction and the endless belt attracts an uppermost sheet placed on top of multiple sheets accommodated in a sheet container to separate the uppermost sheet from the multiple sheets and feed the uppermost sheet in a sheet conveyance direction. The charging member electrode contacts the outer layer of the endless belt between which a nip having a predetermined length is formed. An interior surface of the charging member and the endless belt defines a space across which electric discharge is performed to charge the outer layer of the endless belt. A size of the space and the predetermined length of the nip in the sheet conveyance direction defines a basic charging region. A length of the basic charging region in the sheet conveyance direction is smaller than a length of a unit charging region in which an electric charge of either positive polarity or negative polarity is held on the outer layer of the endless belt in a direction of rotation of the endless belt.

The length of the basic charging region may be smaller than one half of a cycle of a waveform of the alternating voltage applied from the charging member to the endless belt.

The charging member may include a charging roller having a diameter smaller than the length of the unit charging region.

The diameter of the charging roller may be smaller than one half of a cycle of a waveform of the alternating voltage applied from the charging roller to the endless belt.

Further, in one exemplary embodiment, an image forming apparatus includes a sheet container to contain multiple sheets therein including an uppermost sheet placed on top thereof, and the endless belt and the charging member included in the above-described sheet feeding unit.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating a positional relation of a charging roller and an endless belt according to a background image forming apparatus;

FIG. 2 is a schematic view of an image forming apparatus according to an example embodiment of the present patent application;

FIG. 3 is a perspective view of a sheet supplying device incorporated in the image forming apparatus shown in FIG. 2, according to an example embodiment of the present patent application;

FIG. 4 is a perspective view of a sheet feeding unit incorporated in the sheet supplying device shown in FIG. 3, according to Example Embodiment 1 of the present patent application;

FIG. 5 is a side view of the sheet feeding unit shown in FIG. 4, according to Example Embodiment 1 of the present patent application;

FIG. 6A is a side view of an example of the sheet feeding unit shown in FIG. 4, where the sheet feeding unit contacting a uppermost sheet of a stack of sheets, according to Example Embodiment 1 of the present patent application;

FIG. 6B is a side view of an example of the sheet feeding unit shown in FIG. 4, where the sheet feeding unit separating from the stack of sheets, according to Example Embodiment 1 of the present patent application;

FIG. 7A is a schematic diagram illustrating a position of a charging blade in relation with an endless belt member, models of electrical charges of a charging belt, and sine waves for applying voltage to the charging blade, according to Example Embodiment 1 of the present patent application;

FIG. 7B is a schematic diagram illustrating a position of a leading edge of the charging blade in relation with the endless belt member with description of a small gap, a basic charging region, and a nip, according to Example Embodiment 1 of the present patent application;

FIG. 8A is a schematic diagram illustrating square waves for charging and discharging a belt included in the sheet feeding unit shown in FIG. 5, according to Example Embodiment 1 of the present patent application;

FIG. 8B is another schematic diagram illustrating square waves for charging and discharging a belt included in the sheet feeding unit shown in FIG. 5, according to Example Embodiment 1 of the present patent application;

FIG. 8C is a schematic diagram illustrating sine waves for charging and discharging a belt included in the sheet feeding unit shown in FIG. 5, according to Example Embodiment 1 of the present patent application;

FIG. 8D is another schematic diagram illustrating sine waves for charging and discharging a belt included in the sheet feeding unit shown in FIG. 5, according to Example Embodiment 1 of the present patent application;

FIG. 9 is a schematic diagram illustrating a status of a sheet on the electrically charged endless belt member, according to Example Embodiment 1 of the present patent application;

FIG. 10 is a schematic diagram illustrating a position of the charging blade in relation with the endless belt member, models of electrical charges of the charging belt, and square waves for applying voltage to the charging blade, according to Example Embodiment 1 of the present patent application;

FIG. 11 is a side view of another example of the sheet feeding unit shown in FIG. 4, according to Example Embodiment 1 of the present patent application;

FIG. 12 is a perspective view of another example of the sheet feeding unit shown in FIG. 4, according to Example Embodiment 1 of the present patent application;

FIG. 13 is a side view of another example of the sheet feeding unit shown in FIG. 4, according to Example Embodiment 1 of the present patent application;

FIG. 14 is a side view of the sheet feeding unit of FIG. 13, illustrating an operation of separation of a uppermost sheet of the stack of sheets;

FIG. 15 is a perspective view of a sheet feeding unit according to Example Embodiment 2 of the preset patent application; and

FIG. 16 is a schematic diagram illustrating a position of a charging roller in relation with an endless belt member, models of electrical charges of a charging belt, and sine waves for applying voltage to the charging roller, according to Example Embodiment 2 of the present patent application.

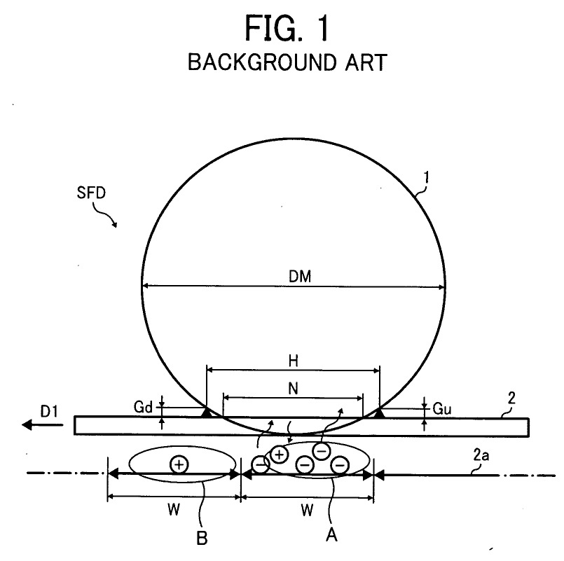

### DETAILED DESCRIPTION OF THE PREFERRED EMBODIMENTS

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present patent application.

The terminology used herein is for the purpose of describing particular embodiments only and is not intended to be limiting of the present patent application. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Descriptions are given, with reference to the accompanying drawings, of examples, exemplary embodiments, modification of exemplary embodiments, etc., of an image forming apparatus according to the present patent application. Elements having the same functions and shapes are denoted by the same reference numerals throughout the specification and redundant descriptions are omitted. Elements that do not require descriptions may be omitted from the drawings as a matter of convenience. Reference numerals of elements extracted from the patent publications are in parentheses so as to be distinguished from those of exemplary embodiments of the present patent application.

The present patent application includes a technique applicable to any image forming apparatus. For example, the technique of the present patent application is implemented in the most effective manner in an electrophotographic image forming apparatus.

In describing preferred embodiments illustrated in the drawings, specific terminology is employed for the sake of clarity. However, the disclosure of the present patent application is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present patent application are described.

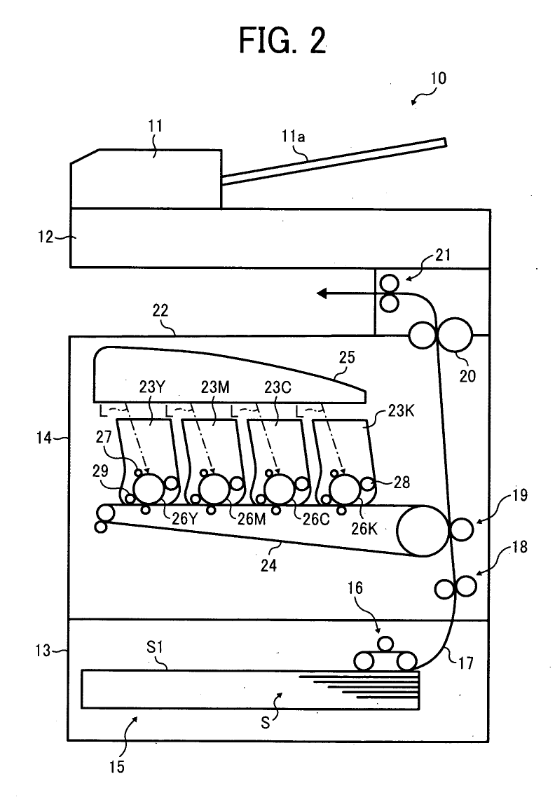

FIG. 2 is a schematic view of the image forming apparatus 10.

As illustrated in FIG. 2, the image forming apparatus 10 includes an automatic document feeder (ADF) 11, a document reader 12, a sheet supplying device 13, an image forming device 14, a fixing unit 20, a pair of sheet discharging rollers 21, and a sheet discharging tray 22.

As illustrated in FIG. 2, the image forming apparatus 10 may be a copier, a facsimile machine, a printer, a multifunction printer having at least one of copying, printing, scanning, plotter, and facsimile functions, or the like. The image forming apparatus 1 may form an image by an electrophotographic method, an inkjet method, and/or the like. According to this example embodiment of the present patent application, the image forming apparatus 1 functions as a copier for forming an image on a recording medium by the electrophotographic method.

The ADF 11 is mounted on the document reader 12. The ADF 11 includes a document sheet tray 11a to hold a stack of sheets thereon. The ADF 11 separates each sheet one by one from the stack of sheets on the document sheet tray 11a to automatically feed the separated sheet to the document reader 12.

The document reader 12 reads image data of the sheet fed from the ADF 11 on a contact glass mounted thereon.

The sheet supplying device 13 is disposed below the image forming device 14. The sheet supplying device 13 accommodates a stack of sheets S therein to supply an uppermost sheet S1 separated from the stack of sheets to the image forming device 14.

The image forming device 14 forms an image on the uppermost sheet S1 supplied by the sheet supplying device 13 according to the image data read in the document reader 12.

According to this example embodiment, the image forming device 14 can separate from the sheet supplying device 13 for supplying the uppermost sheet S to the image forming device 14.

The sheet supplying device 13 includes a sheet container 15 and a sheet feeding unit 16.

The sheet container 15 is a cassette serving as a sheet containing member that loads a stack of sheets S therein, and the sheet feeding unit 16 separates and feeds the uppermost sheet S1 that is placed on top of the stack of sheets loaded in the sheet container 15.

The uppermost sheet S1 separated by the sheet feeding unit 16 travels in a conveyance path 17 that passes through a nip formed between a pair of conveyance rollers 18 and a secondary transfer nip formed between a transfer roller 19 and a roller facing the transfer roller 19 with an intermediate transfer belt 24 interposed therebetween.

Through the conveyance path 17, the uppermost sheet S1 is conveyed forward by the pair of conveyance rollers 18 and receives a toner image formed in the image forming device 14 at the secondary transfer nip of the transfer roller 19. The toner image is then fixed to the uppermost sheet S1 in the fixing unit 20 by application of heat and pressure, and is finally discharged to the sheet discharging tray 22 by the pair of sheet discharging rollers 21.

The image forming device 14 includes four image forming units 23 (specifically, an image forming unit 23Y for forming yellow toner image, an image forming unit 23C for forming cyan toner image, an image forming unit 23M for forming magenta toner image, and an image forming unit 23K for forming black toner image), an intermediate transfer belt 24 that serves as a transfer belt, and an optical writing device 25.

The optical writing device 25 receives color separation image data transmitted from an external device such as a personal computer and a word processor and image data of original documents read by the document reader 12 and converts the image data to a signal for light source driving. Accordingly, the optical writing device 25 drives semiconductor laser in each laser light source unit and emits light beams L.

The image forming units 23Y, 23C, 23M, and 23K may form respective single-color toner images different from each other. The image forming units 23Y, 23C, 23M, and 23K includes a photoconductor 26 (specifically, a photoconductor 26Y for carrying yellow toner image thereon, a photoconductor 26C for carrying cyan toner image thereon, a photoconductor 26M for carrying magenta toner image thereon, and a photoconductor 26K for carrying black toner image thereon), and image forming components disposed around the photoconductor 26. The image forming components included in each of the image forming units 23Y, 23C, 23M, and 23K shown in FIG. 2 are a charging unit 27, a developing unit 28, and a cleaning unit 29.

The photoconductor 26 is a cylindrical image carrier that is rotated by a drive source, not illustrated, in a clockwise direction in FIG. 2. The photoconductor 26 has a photoconductive layer over an outer surface thereof. The light beams L emitted by the optical writing device 25 irradiates the outer surface of the photoconductor 26 to optically write an electrostatic latent image according to image data.

The charging unit 27 is disposed contacting the photoconductor 26 to uniformly charge the outer surface of the photoconductor 26.

The developing unit 28 supplies toner to the outer surface of the photoconductor 26 to develop the electrostatic latent image into a visible toner image. In this example embodiment, a non-contact type developing unit that does not directly contact the photoconductor 26 is employed.

The cleaning unit 29 is a brush-contact-type unit in which a brush member thereof is disposed slidably contacting the outer surface of the photoconductor 26 to remove residual toner remaining on the outer surface of the photoconductor 26.

The intermediate transfer belt 24 is an endless belt member including a resin film or a rubber material. The toner image is transferred from the photoconductor 26 onto a surface of the intermediate transfer belt 24 before being further transferred onto the sheet S at the secondary transfer nip formed by the transfer roller 19.

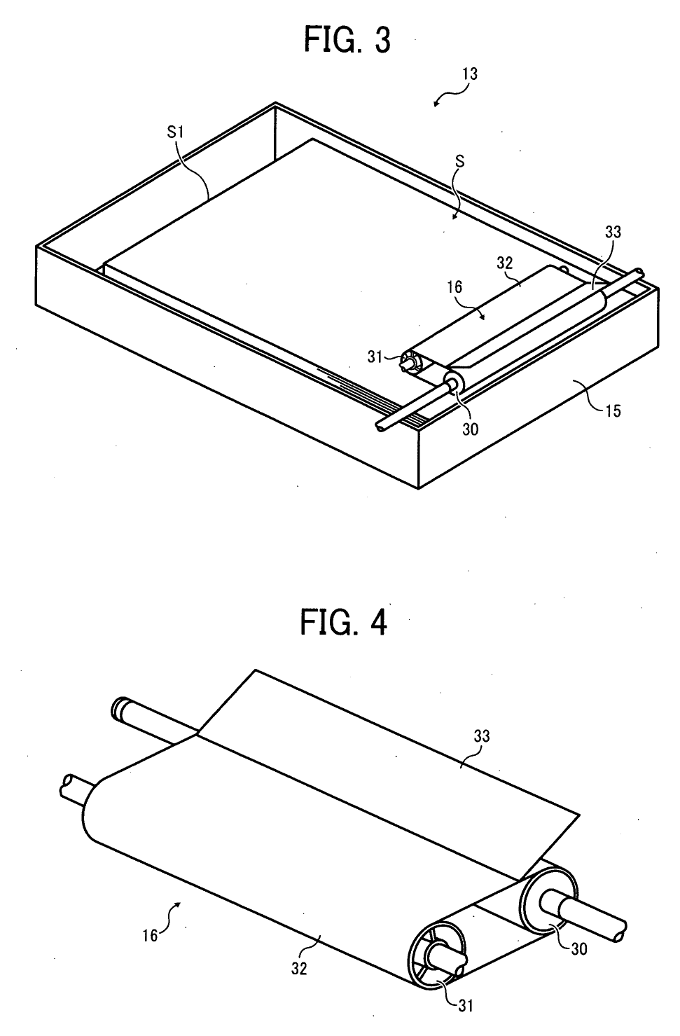

FIG. 3 illustrates a perspective view of the sheet supplying device 13 incorporated in the image forming apparatus 10.

As previously noted, the sheet supplying device 13 in FIG. 3 includes the sheet container 15 in which the stack of sheets S including the uppermost sheet S1 are accommodated and the sheet feeding unit 16. A width or a direction along an axial direction of the sheet feeding unit 16 is narrower or smaller than that of the uppermost sheet S1 and is disposed in the vicinity of the center in the width direction of the uppermost sheet S1.

Alternatively the width of the sheet feeding unit 16 can be equal to or greater than that of the uppermost sheet S1. Further, two or more sheet feeding units 16 can be disposed along the width direction of the uppermost sheet S1 while one sheet feeding unit 16 is provided in the vicinity of the center in the width direction of the uppermost sheet S1 in the sheet supplying device 13 in FIG. 3.

Now a description is given of a sheet feeding unit 16 according to Example Embodiment 1.

FIG. 4 is a perspective view of the sheet feeding unit 16 disposed in the sheet supplying device 13 shown in FIG. 3.

As illustrated in FIG. 3 and FIG. 4, the sheet feeding unit 16 includes a drive roller 30, a driven roller 31, an endless belt 32, and a charging blade 33. In the separation feeder 16, the endless belt 32 includes a dielectric looped over the drive roller 30 and the driven roller 31. The dielectric of the endless belt 32 has a resistivity not smaller than about 10⁸ Ω·cm. For example, the dielectric of the endless belt 32 may be a polyethylene terephthalate film having a thickness of about 100 μm. The endless belt 32 is contacted by a charging member having a blade shape and extending in a given direction.

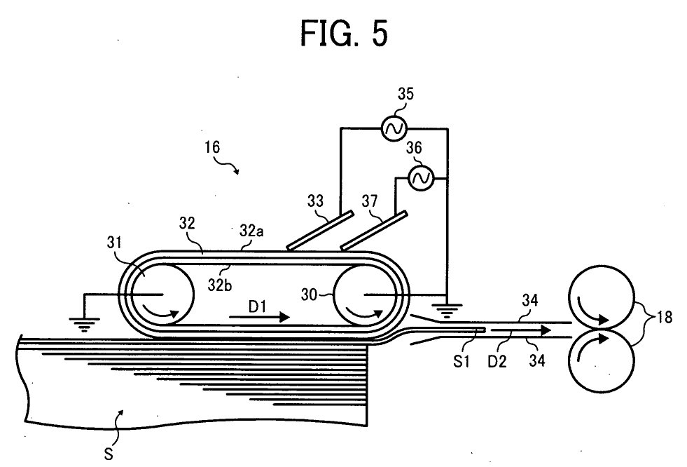

FIG. 5 is a side view of the sheet feeding unit 16. As illustrated in FIG. 5, the sheet feeding unit 16 further includes a pair of guide members 34 that defines the conveyance path 17 (refer back to FIG. 2). The sheet feeding unit 16 further includes a charging power source 35, a discharging power source 36, a discharging power source 36, and/or a discharging electrode 37.

The endless belt 32 includes a front layer 32a having a resistivity of about 10⁸ Ω·cm or greater and/or a back layer 32b having a resistivity of about 10⁶ Ω·cm or smaller to maintain a good charging state. The endless belt 32 rotates in a belt rotation direction as indicated by arrow “D1” shown in FIG. 5.

The charging blade 33 that serves as a charging electrode uses the back layer 32b of the endless belt 32 as a grounded opposing electrode. Therefore, the charging blade 33 may contact the front layer 32a of the endless belt 32 at any position on the front layer 32a of the endless belt 32. The stack of sheets S is disposed at a position at which the uppermost sheet S1 is attracted by the endless belt 32 at a sufficient area.

A surface of the drive roller 30 includes a conductive rubber layer having a resistivity of about 10⁶ Ω·cm. A surface of the driven roller 31 includes metal. The drive roller 30 and the driven roller 31 are grounded.

The drive roller has a small diameter that is suitable for separating the uppermost sheet S1 from the endless belt 32 using a curvature. For example, the great curvature caused by the small diameter of the drive roller 30 separates the uppermost sheet S1 attracted by the endless belt 32 from the endless belt 32 looped over the drive roller 32, and the endless belt 32 driven by the drive roller 32 feeds the separated uppermost sheet S1 toward the conveyance path 17 formed by the pair of guide members 34 provided downstream from the drive roller 30 in a sheet conveyance direction indicated by arrow “D2” shown in FIG. 5.

According to Example Embodiment 1, the charging blade 33 contacts the endless belt 32 at a position near a position at which the endless belt 32 is looped over the drive roller 30. The charging blade 33 is connected to the charging power source 35 for generating an alternating current.

The discharging electrode 37 contacts or is disposed close to the endless belt 32 at a position upstream from the charging blade 33 and downstream from a separation position at which the uppermost sheet S1 separates from the endless belt 32 in the rotation direction D1 of the endless belt 32. The discharging electrode 37 is connected to the discharging power source 36 serving as an alternating power source.

A controller controls the charging power source 35 and the discharging power source 36 in such a manner that a force of attraction of the endless belt 32 for attracting the uppermost sheet S1 is removed from the endless belt 32 when a leading edge of the uppermost sheet S1 contacts the pair of conveyance rollers 18. Alternatively, the discharging electrode 37 may be omitted. The following describes operations of the image forming apparatus 10 when the discharging electrode 37 is not provided.

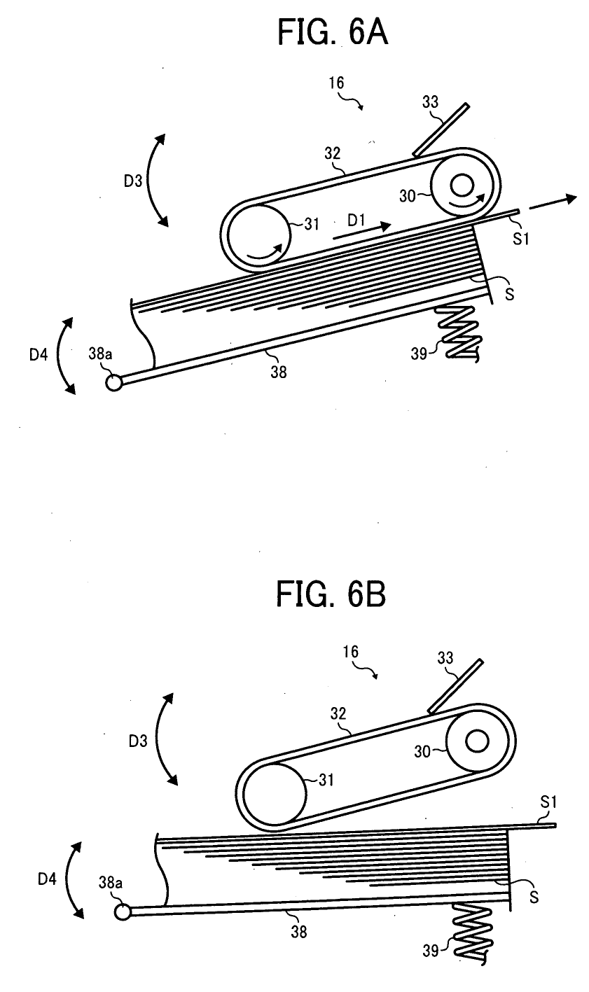

FIG. 6A and FIG. 6B are side views of the sheet feeding unit 16 according to Example Embodiment 1 of the present patent application. FIG. 6A illustrates a contact state of the sheet feeding unit 16 in which the endless belt 32 contacts the uppermost sheet S1 placed on top of the stack of sheets S. FIG. 6B illustrates a separation state of the sheet feeding unit 16 in which the endless belt 32 separates from the stack of sheets S.

As illustrated in FIGS. 6A and 6B, the sheet feeding unit 16 further includes a bottom plate 38, a rotation shaft 38a, and a push-up member 39.

In FIG. 6A, the endless belt 32 is disposed at a position at which the endless belt 32, which is looped over the drive roller 30 serving as a rotation shaft of the endless belt 32 rotating in a rotation direction as indicated by arrow “D3”, contacts the leading edge of a front side (e.g., an upper side) of the uppermost sheet S1 of the stack of sheets S placed on the bottom plate 38 pushed up by the push-up member 39 that is disposed between the bottom plate 38 and an inner side of the bottom surface of the sheet container 15 (see FIG. 2). The rotation shaft 38a is provided at one end of the bottom plate 38 in the sheet conveyance direction D2. When the push-up member 38a pushes up another end of the bottom plate 38 opposite to the one end provided with the rotation shaft 38a in the sheet conveyance direction D2, the bottom plate 38 rotates about the rotation shaft 38a in a rotation direction “D4” to press the uppermost sheet S1 against the endless belt 32.

The movement of the bottom plate 38 rotating about the rotation shaft 38a is driven by an actuator, not illustrated, such as a solenoid, which is provided to the sheet container 15. The endless belt 32 rotates about the drive roller 30 in a rotation direction as indicated by arrow D3, which is a substantially direction. When the bottom plate 38 is pushed up by the push-up member 39 to rotate about the rotation shaft 38a in the rotation direction D4 the driven roller 30 is also pushed up along with the bottom plate 38 to rotate about the drive roller 30 in the rotation direction D3. When the driven roller 31 is not pushed up by the bottom plate 38, the driven roller 31 is located at a lower position by its own weight, as illustrated in FIG. 6B.

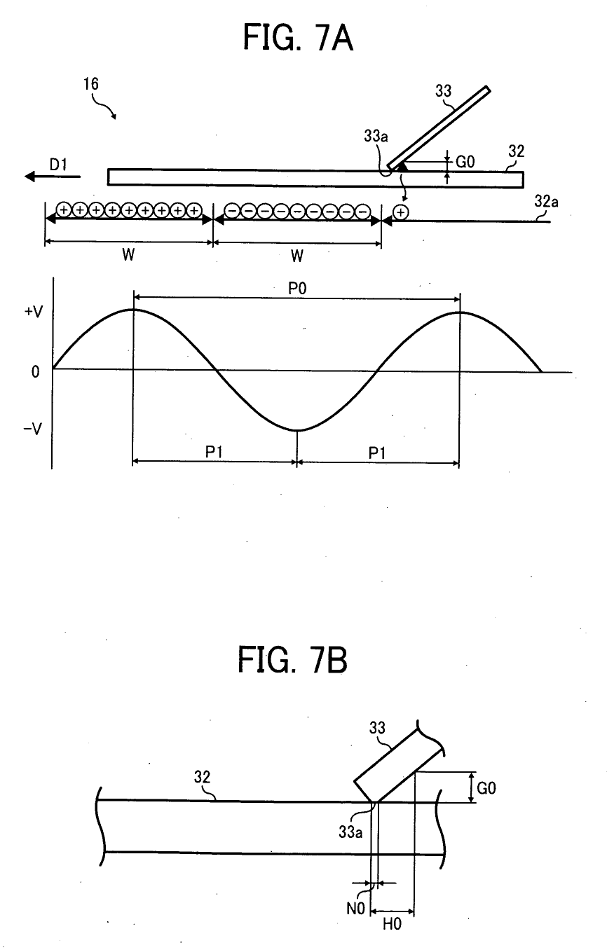

FIG. 7A and FIG. 7B are schematic diagrams illustrating a position of the charging blade 33 in the sheet feeding unit 16. FIG. 7A illustrates the charging blade 33 in relation with the endless belt 32, models of electrical charges on an outer layer 32a of the endless belt 32, and sine waves for applying voltage to the charging blade 33 in the sheet feeding unit 16. FIG. 7B illustrates a leading edge 33a of the charging blade 33 in relation with the endless belt 32.

As illustrated in FIG. 7A, the leading edge 33a of the charging blade 33 contacts the outer layer 32a of the endless belt 32 to form a nip N0 therebetween, which is a contact area of the leading edge 33a of the charging blade 33. Hereinafter, the length of the nip N0 (shown in FIG. 7B) in a sheet conveyance direction D2 is also referred to as a nip length.

The charging blade 33 contacts the outer layer 32a of the endless belt 32 with tilted in an obliquely right upward direction. The charging blade 33 and the endless belt 32 form a small gap G0, in which electrical charge is discharged to the outer layer 32a of the endless belt 32.

The length of nip N0 is determined considering an elastic modulus and a pressure force of the charging blade 33, deflection of the endless belt 32, and so forth. The size of the small gap G0 is determined considering a voltage applied from the charging power source 35 to the charging blade 33, a thickness and dielectric constant of the endless belt 32.

The length of a basic charging region H0 is determined based on the length of the nip N0 formed between the leading edge 33a of the charging blade 33 and the endless belt 32 and the distance of the small gap G0 in which electric discharge occurs. The basic charging region H0 is smaller than the unit charging region W of the endless belt 32 to which an electric charge having a polarity identical to the basic charging region H0 in the belt rotation direction D1 are applied.

As shown in FIG. 7A, positive charge and negative charge adhering to the outer layer 32a of the endless belt 32 can be illustrated. In FIG. 7A, the basic charging region H0 is smaller than the unit charging region W on the outer layer 32a of the endless belt 32 on which the positive charge and the negative charge are applied by turns of predetermined periods.

The patterns of the positive and negative charges adhere to the outer layer 32a of the endless belt 32 by an action of a voltage applied from the charging power source 35 to the charging blade 33 in the belt rotation direction D1 of the endless belt 32. When the period of a sine wave of the voltage in FIG. 7A is defined as a full charging pitch P0, the basic charging region H0 is smaller than a half charging pitch P1 that is one half of the full charging pitch P0.

In the sheet feeding unit 16 having the above-described structure, a feeding signal rotates the drive roller 30. The charging power source 35 depicted in FIG. 5 applies an alternating voltage via the charging blade 33 to the endless belt 32 rotated by the driving roller 30. As shown in FIG. 7A, the applied alternating voltage is discharged in the small gap G of the charging blade 33 to form a charge pattern in which pitches in a range from about 2 mm to about 15 mm are alternately provided on the outer layer 32a of the endless belt 32 according to a frequency of the charging power source 35 for generating the alternating current and a rotation speed (e.g., a circumferential speed) of the endless belt 32.

Instead of the alternating current, the charging power source 35 may apply a direct current in which high and low potentials are alternately provided. According to Example Embodiment 1, the charging power source 35 applies an alternating current having amplitude of from about 3 KV to about 4 KV (from ±1.5 to ±2.0) to the outer layer 32a of the endless belt 32, as shown in FIG. 7A.

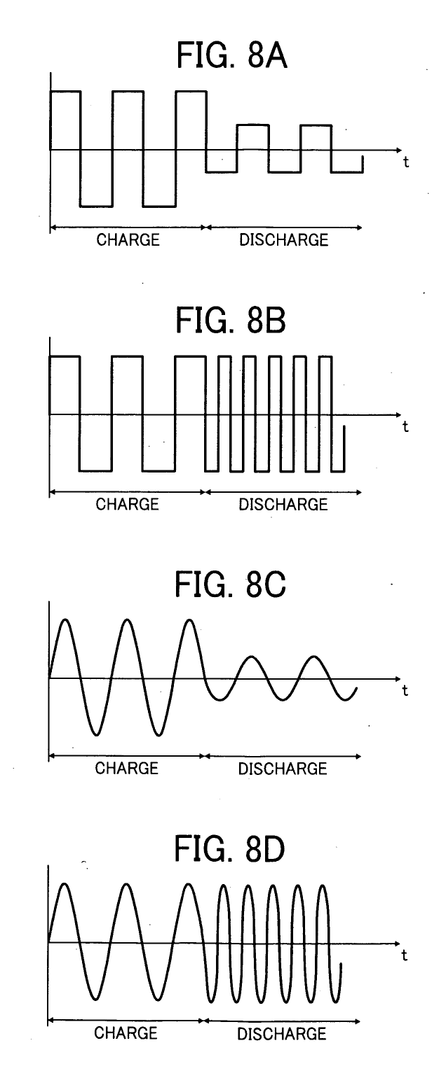

FIGS. 8A through 8B show schematic diagrams illustrating waveforms for charging and discharging the endless belt 32.

As illustrated in FIG. 8A, a voltage is controlled to charge and discharge the outer layer 32a of the endless belt 32. For example, the voltage applied by the charging power source 35 may be decreased to remove the charge pattern formed on the outer layer 32a of the endless belt 32.

As illustrated in FIG. 8B, frequency of the charging power source 35 may be increased to shorten the pitches of the charge pattern formed on the outer layer 32a of the endless belt 32. Thus, the force of attraction of the endless belt 32 for attracting the uppermost sheet S1 may be decreased according to the Maxwell stress.

FIGS. 8A and 8B illustrate square waves formed by the direct current alternately applied. Similarly, the alternating current may be used. FIGS. 8C and 8D illustrate sine waves formed by the alternating current, which are used in Example Embodiment 1.

The endless belt 32 formed with the positive and negative charge patterns alternatively on the outer layer 32a contacts the leading edge of the front side (e.g., the upper side) of the uppermost sheet S1 at a position at which the endless belt 32 is looped over the driven roller 31. A non-uniform electric field formed by the positive and negative charge patterns on the outer layer 32a of the endless belt 32 applies the Maxwell stress to the dielectric, uppermost sheet S1. Accordingly, the uppermost sheet S1 is attracted to the endless belt 32, and is held and conveyed by the endless belt 32.

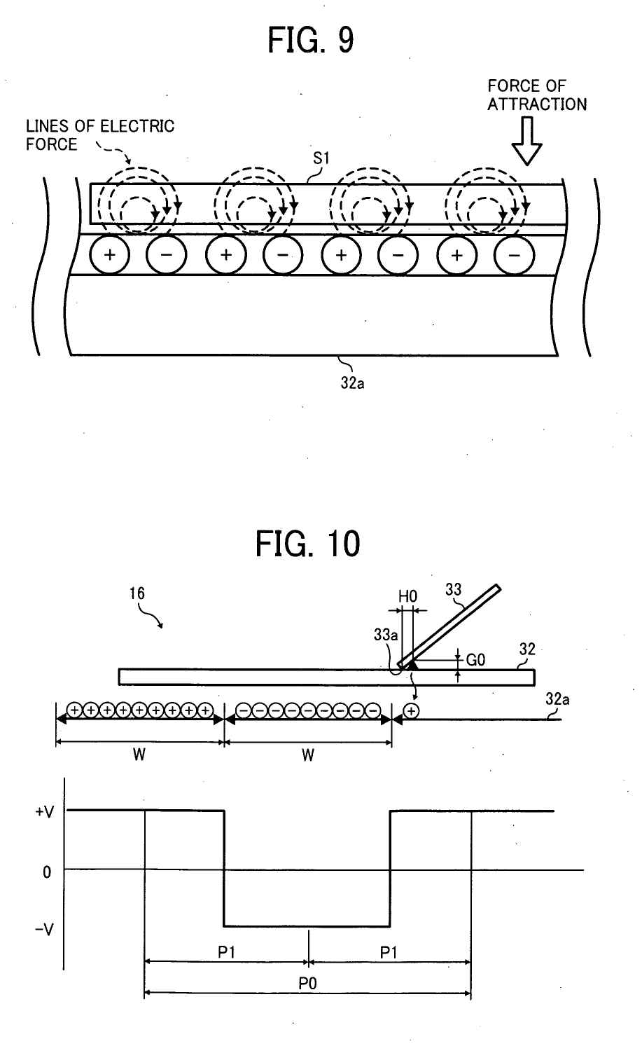

FIG. 9 illustrates a status of the uppermost sheet S1 on the endless belt 32. Now, principle of electrostatic attraction of the uppermost sheet S1 to the endless belt 32 is explained with FIG. 9.

As noted above, the charging blade 22 applies the positive charge and negative charge to the outer layer 32a of the endless belt 32. On the charged outer layer 32a of the endless belt 32, lines of electric force are generated in a direction from the positive charge to the negative charge.

As noted above, the front side (e.g., the upper side) of the uppermost sheet S1 on which the endless belt 32 contacts the uppermost sheet S1 is charged to a given polarity. Resulting from the effect of the lines of electric forces on the endless belt 32, a rear side (e.g., a lower side) of the uppermost sheet S1 that is opposite the front side of the uppermost sheet S1 is also charged to a same polarity as the front side of the uppermost sheet 51. The lines of electric force shown in phantom on the front side of the uppermost sheet S1 on which the outer layer 32a of the endless belt 32 contacts the uppermost sheet S1 has a high density, and the lines of electric force on the rear side of the uppermost sheet S1 on which the outer layer 32a of the endless belt 32 does not contact the uppermost sheet S1 has a low density.

This action causes a difference of charge between the front side and the rear side of the uppermost sheet S1. The difference of charge generates a force of attraction for attracting the uppermost sheet S1 to the endless belt 32. This action of the Maxwell stress is caused at a boundary of positive charge and negative charge.

Models of the positive charge and the negative charge are conveniently illustrated one by one in an alternative manner in FIG. 9. The outer layer 32a of the endless belt 32 is charged with the positive charge and the negative charge arranged at constant pitches (e.g., the unit charging region W) in the belt rotation direction D1 of the endless belt 32. The more the charging pitch decreases, the smaller the interval between the adjacent electric potentials become. Therefore, a distance of electric field generated on the side of the uppermost sheet S1 in a direction of load of the stack of sheets S decreases, and thus a distance for applying the force of attraction to the uppermost sheet S1 decreases. Consequently, the smaller charging pitch can further decrease the force of attraction for attracting the uppermost sheet S1 to the endless belt 32 based on the Maxwell stress.

By contrast, the curvature of the drive roller 30 separates the uppermost sheet S1 from the endless belt 32. The uppermost sheet S1 is fed in the sheet conveyance direction D2 depicted in FIG. 2 toward the pair of conveyance rollers 18 through the conveyance path 17 defined by the pair of guide members 34. The pair of conveyance rollers 18 feeds the uppermost sheet S1 toward the image forming device 14 depicted in FIG. 2, only with a conveyance force of the pair of conveyance rollers 18 without any influence from the endless belt 32.

The drive roller 30 is connected via a driving shaft to a drive transmission blocking mechanism such as a clutch provided between the drive roller 30 depicted in FIG. 5 and a driver, not illustrated. When the uppermost sheet S1 reaches the pair of conveyance rollers 18 depicted in FIG. 5, the clutch interrupts transmission of a driving force from the driver to the drive roller 30. Accordingly, the drive roller 30 rotates freely. In other words, the clutch decreases load applied by the driver to the sheet feeding unit 16 depicted in FIG. 5 and the uppermost sheet S1.

The force of attraction generated by the charge pattern on the outer layer 32a of the endless belt 32 acts on the uppermost sheet S1 as well as other sheets of the stack of sheets S other than the uppermost sheet S1 for a predetermined period of time after the endless belt 32 attracts the uppermost sheet S1. However, after the given period has elapsed, the force of attraction acts on the uppermost sheet S1 for a period of time longer than the other sheets. This action increases the force of attraction for attracting the uppermost sheet S1 and decreases the force of attraction for attracting the other sheets of the stack of sheets S.

Namely, if the endless belt 32 contacts the uppermost sheet S1 for a longer period of time, even when the sheet feeding device 16 does not include a multi-feeding blocker, the uppermost sheet S1 can be separated from other sheets of the stack of sheets S after the predetermined period of time elapses. Consequently, a linear speed of the pair of conveyance rollers 18 depicted in FIG. 5 is identical with a linear speed of the endless belt 32. For example, when the pair of conveyance rollers 18 is driven intermittently at proper times, the endless belt 32 is also driven intermittently. Accordingly, the endless belt 32 can contact the uppermost sheet S1 for a longer period of time.

Further, the endless belt 32 is disposed such that a second sheet S2 is not attracted to the endless belt 32 before the trailing edge of the uppermost sheet S1 reaches a position facing the driven roller 31.

The endless belt 32 of the sheet feeding unit 16 is charged or discharged while the endless belt 32 rotates. Accordingly, if the endless belt 32 contacts the stack of sheets in accordance with rotation of the endless belt 32, the uppermost sheet S1 is pushed up by the bottom plate 38 depicted in FIG. 6A and may be fed during charging and discharging.

According to Example Embodiment 1, as illustrated in FIG. 6B, an actuator such as a solenoid is driven to push up the bottom plate 38 rotating about the rotation shaft 38a against a biasing force of the spring 39. With this action, the endless belt 32 is separated from the stack of sheets S.

When the endless belt 32 is not pushed up by the bottom plate 38, the driven roller 31 rotating about the drive roller 30 is located at a lower position by its own weight, as illustrated in FIG. 6B. However, when the driven roller 31 is restricted to move downwardly, the endless belt 32 does not contact the stack of sheets S according to the driven roller 31. As a result, the uppermost sheet S1 may not be fed mistakenly.

According to Example Embodiment 1, the leading edge 33a of the charging blade 33 slidably contacts the endless belt 32 to form the nip N0 having the predetermined length therebetween, and electric discharge occurs at the small gap G formed between the charging blade 33 and the endless belt 32 to electrically charge the outer layer 32a of the endless belt 32. In Example Embodiment 1, the length of the basic charging region H determined based on the length of the nip N0 and the distance of the small gap G0 is smaller than the length of the half charging pitch P1 of the alternating charge that is applied from the charging blade 33 to the endless belt 32 to electrically discharge the alternating voltage at a position upstream from the charging blade 33 in the belt rotation direction D1 of the endless belt 32. This can attain a configuration in which the basic charging region H0 determined based on the nip N0 and the small gap G0 is smaller than the unit charging region W holding an electric charge having a single polarity (e.g., a positive charge or a negative charge) to the endless belt 32 in the belt rotation direction D1.

This configuration of the sheet feeding unit 16, as a result, can prevent movement of an electric charge or electric charges on the endless belt 32 over the nip N0 between the charging blade 33 and the endless belt 32, inhibit immigration of the electric charge(s) having an opposite polarity to a predetermined polarity on the endless belt 32, and prevent generation of electric charge(s) having an opposite polarity to that of the electric charge(s) on the endless belt 32 at a position downstream from the charging blade 33 in the belt rotation direction D1 of the endless belt 32. Consequently, the entire unit charging regions W of the endless belt 32 can maintain the normal charging state without being adversely affected by the movement of the electric charge(s) and immigration of the electric charge(s) having an opposite polarity to the predetermined polarity.

As a result, the outer layer 32a of the endless belt 32 can be charged with the alternating charge, which is an alternating combination of the positive charge and the negative charge, at smaller pitches to cause the endless belt 32 to generate a sufficient force of attraction for attracting the uppermost sheet S1.

With this configuration, the sheet feeding unit 16 can quickly increase the force of attraction for attracting the uppermost sheet S1 of the stack of sheets loaded in the sheet container 15 to the endless belt 32 and can quickly decrease the force of attraction for attracting a subsequent sheet S2 and any other subsequent sheets to the endless belt 32. Accordingly, the time required for separating the sheets from the endless belt 32 can be decreased for better productivity of separation of the uppermost sheet S1.

A conventional sheet feeding unit with a method for electrostatically attracting sheets has some drawbacks. For example, it takes a long time to obtain a sufficient force of attraction for attracting the sheets and to reduce the force of attraction affecting any subsequent sheets, when the electrical resistance of the uppermost sheet S1 is high. In addition, the low electrical resistance of the uppermost sheet S1 provides a less sufficient force of attraction.

By contrast, as described above, the sheet feeding unit 16 according to Example Embodiment 1 can reduce the charging pitch of the alternating charge, and can therefore quickly increase the force of attraction for attracting the uppermost sheet S1 of the stack of sheets loaded in the sheet container 15 to the endless belt 32 and can quickly decrease the force of attraction for attracting a subsequent sheet S2 and any other subsequent sheets to the endless belt 32.

Consequently, the sheet feeding unit 16 can perform feeding operations stably with various types of sheets S loaded in the sheet container 15 even when the environmental condition changes over time and can be highly reliable in separating and feeding sheets S one by one in a fast and robust manner.

A thermohygrometer may be provided in the sheet supplying device 13 depicted in FIG. 3 to detect environmental conditions. A user may operate a control panel provided in the image forming apparatus 10 depicted in FIG. 2 to input or select information about a material of the uppermost sheet S1.

According to Example Embodiment 1, the leading edge 33a of the charging blade 33 is pressed against the outer layer 32a of the endless belt 32. This removes dusts, dirt, corona products and so on remaining on the surface of the outer layer 32a of the endless belt 32 to clean the endless belt 32, the surface of the outer layer 32a of the endless belt 32 can thereby be maintained in a normal state without any additional cleaning unit and can avoid a decrease in force of attraction due to aging.

FIG. 10 illustrates the charging blade 33 in relation with the endless belt 32, models of electrical charges on an outer layer 32a of the endless belt 32, and square waves for applying voltage to the charging blade 33 in the sheet feeding unit 16.

Instead of using the sine waves as illustrated in FIG. 7A, the sheet feeding unit 16 can employ a square wave formed by the direct current alternately applied, as illustrated in FIG. 10. The patterns of the positive and negative charges adhere to the outer layer 32a of the endless belt 32 by an action of a voltage applied from the charging power source 35 to the charging blade 33 in the belt rotation direction D1 of the endless belt 32. The patterns of the positive and negative charges adhere to the outer layer 32a of the endless belt 32 by an action of a voltage applied from the charging power source 35 to the charging blade 33 in the belt rotation direction D1 of the endless belt 32. When the period of the square wave of the voltage in FIG. 10 is defined as a full charging pitch P0, the basic charging region H0 is smaller than a half charging pitch P1 of the full charging pitch P0.

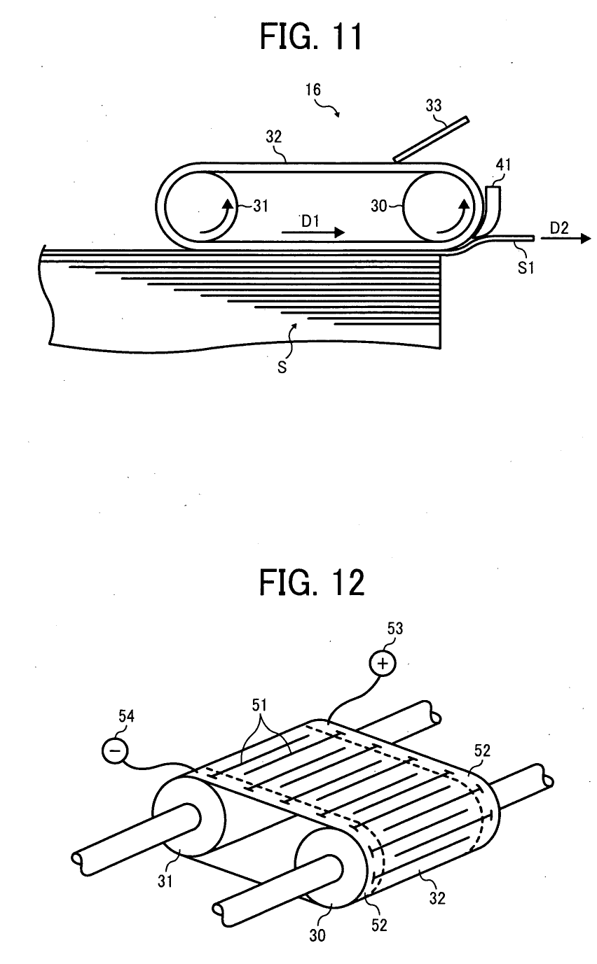

FIG. 11 is a side view of the sheet feeding unit 16. As illustrated in FIG. 11, the sheet feeding unit 16 further includes a separation claw 41.

The curvature of the drive roller 30 separates the uppermost sheet S1 from the endless belt 32. However, the separation claw 41 may be provided to separate the uppermost sheet S1 from the endless belt 32 more precisely.

As described above, according to Example Embodiment 1, for obtaining an electrostatic force of attraction, the charging blade 33 that extends along a predetermined direction of the endless belt 32 applies electric charge to the endless belt 32 to generate an electric field on the endless belt 32. Alternatively, the charging electrode may be a saw-toothed electrode separated from the endless belt 32 in such a manner that a slight gap is provided between the endless belt 32 and the saw-toothed electrode.

FIG. 12 is a perspective view of an example of the sheet feeding unit 16. As illustrated in FIG. 12, the sheet feeding unit 16 includes the drive roller 30, the driven roller 31, the endless belt 32, positive and negative electrodes 51, positive and negative voltage receivers 52, a high-voltage positive power source 53, and/or a high-voltage negative power source 54. The comb-toothed, positive and negative electrodes 51 may be arranged on the endless belt 32 in such a manner that the positive and negative electrodes oppose to each other in a direction perpendicular to the belt rotation direction D1 of the endless belt 32.

The positive and negative voltage receivers 52 may provided on both ends of the endless belt 32 in the direction perpendicular to the belt rotation direction D1 of the endless belt 32, and expose patterns. The high-voltage positive power source 53 applies a positive voltage to a positive side of the positive and negative electrodes 51 via the positive and negative voltage receivers 52. Similarly, the high-voltage negative power source 54 applies a negative voltage to a negative side of the positive and negative electrodes 51 via the positive and negative voltage receivers 52. Accordingly, an electric field is generated on the endless belt 32, and the endless belt 32 exerts a force of attraction to the uppermost sheet S1 of the stack of sheet S to attract the uppermost sheet S1.

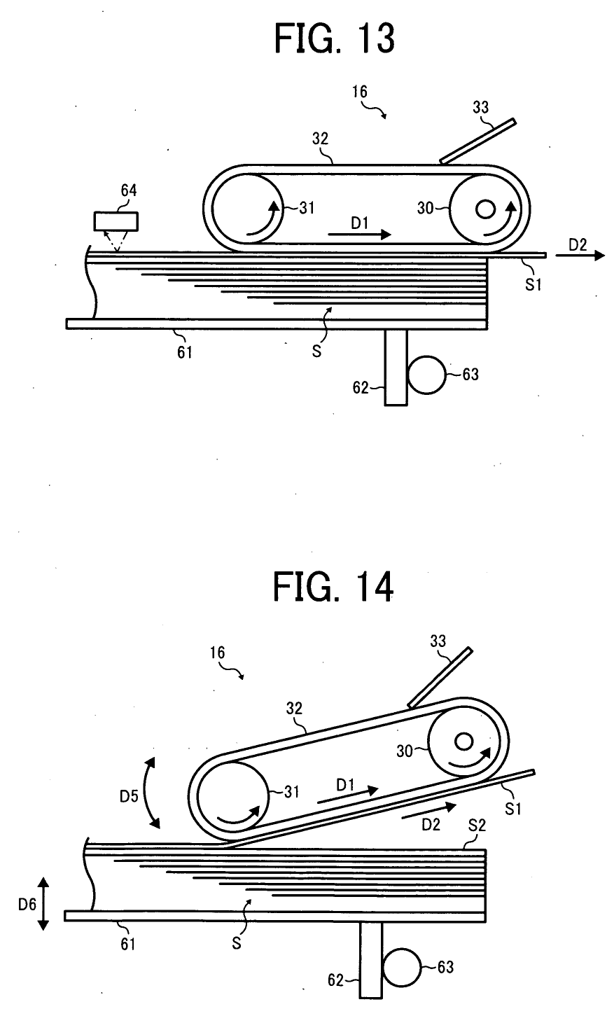

FIG. 13 is a side view of another example of the sheet feeding unit 16. The configuration of the sheet feeding unit 16 shown in FIG. 13 is similar to that of the sheet feeding unit 16 of FIG. 6A and FIG. 6B. In place of the bottom plate 38, the spring 39, and the actuator such as a solenoid provided to the sheet feeding unit 16 in FIG. 6A and FIG. 6b, the sheet feeding unit 16 of FIG. 13 includes a bottom plate 61, a rack 62, a pinion 63, and/or a sensor 64.

Namely, as illustrated in FIG. 13, the bottom plate 61 is interposed between the bottom surface of the sheet container 15 and the stack of sheets S. The rack 62 is mounted on the lower face of the bottom plate 61. The pinion 63 that is rotated by a motor, not illustrated, is engaged with the rack 62.

The rack 62 and the pinion 63 lift and lower the bottom plate 61 in such a manner that the bottom plate 61 is constantly parallel to a horizontal direction.

In this case, the endless belt 32, the drive roller 30, and the driven roller 31 of the sheet feeding unit 16 may be fixedly positioned in the sheet supplying device 13. The sheet supplying device 13 further includes a sensor 64 that serves as a detector to detect a position of the uppermost sheet S1 in a vertical direction. A controller, not illustrated, causes a motor, not illustrated, to control a gap and a pressure between the endless belt 32 and the uppermost sheet S1 according to detection results provided by the sensor 64.

The bottom plate 61 can be attached to the sheet container 15 via the rack 62 by slidably engaging the rack 62 with a cylindrical part projecting from the bottom plate 61 or by slidably engaging both ends in a widthwise direction of the bottom plate 61 with a side plate provided at each end in a widthwise direction of the sheet container 15. Further, the motor may be disposed at a position between the bottom plate 61 and the bottom face of the sheet container 15.

FIG. 14 is a side view of the sheet feeding unit 16, explaining the separating operation of the uppermost sheet S1 from the stack of sheets S. As illustrated in FIG. 14, the driven roller 31 rotates about the drive roller 31 in a direction indicted by arrow D5 in FIG. 14. This configuration may move the driven roller 31 in a direction indicated by arrow D6 in FIG. 14 for separating the uppermost sheet S1 from the stack of sheets S.

Consequently, the bottom plate 61 moves downwardly along the vertical direction D6 to release the status of the endless belt 32 in which the endless belt 32 contacts the uppermost sheet S, thereby rotating the driven roller 31 about the drive roller 30 in the direction D5, which is a counterclockwise direction in FIG. 14. By this movement, the endless belt 32 can separate the uppermost sheet S1 from the stack of sheets S. As a result, the uppermost sheet 51 reliably separates from the stack of sheets S and can reliably prevent the uppermost sheet S1 from multi-feeding.

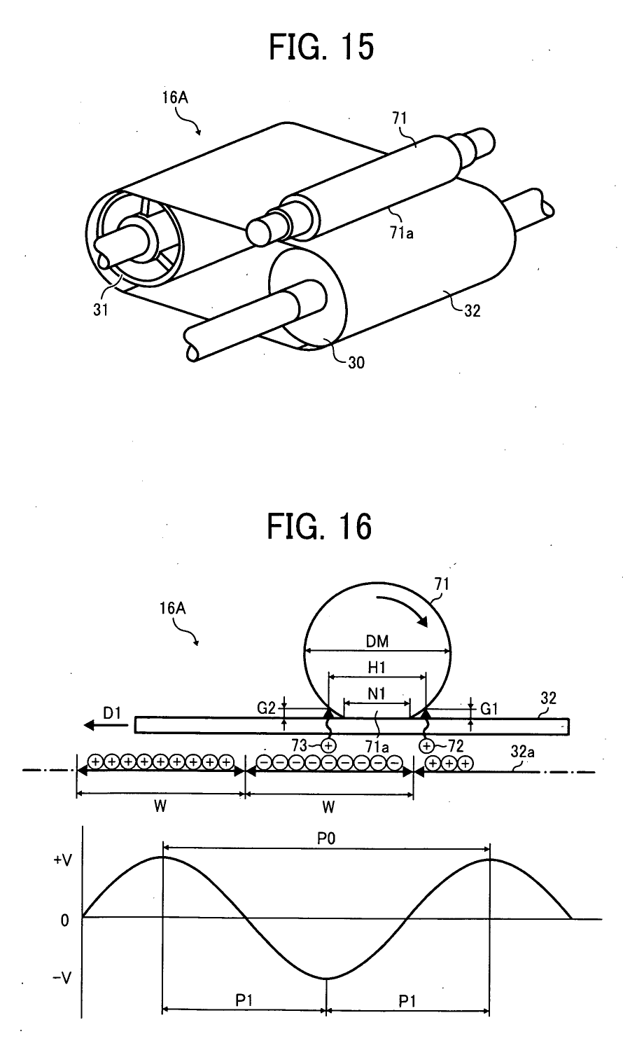

Referring to FIGS. 15 and 16, a description is given of the sheet feeding unit 16 and the image forming apparatus 10 according to another embodiment or Example Embodiment 2 of the present patent application. FIG. 15 illustrates a sheet feeding unit 16A and FIG. 16 illustrates a positional relation of a charging roller 71 and the endless belt 32 of the sheet feeding unit 16A.

The sheet feeding unit 16A according to Example Embodiment 2 employs the charging roller 71 as a charging member replaced by the charging blade 33 employed in Example Embodiment 1. Elements or components of the sheet feeding unit 16A according to Example Embodiment 2 may be denoted by the same reference numerals as those of the sheet feeding unit 16 according to Example Embodiment 1 and the descriptions thereof are omitted or summarized.

In the sheet feeding unit 16A illustrated in FIGS. 15 and 16, the charging roller 71 includes an outer surface 71a that rotatably and slidably contacts the endless belt 32 to form a nip N1 or a contact portion therebetween. Hereinafter, a length of the nip N1 formed between the outer surface 71a of the charging roller 71 and the endless belt 32 is referred to as a nip length.

As illustrated in FIG. 16, the charging roller 71 contacts the outer layer 32a of the endless belt 32 in the belt rotation direction D1. The charging roller 71 and the endless belt 32 form two small gaps G1 and G2, in which electrical charge is discharged to the outer layer 32a of the endless belt 32 at the small gaps G1 and G2; the small gap G1 is formed upstream from the nip of the charging roller 71 and the endless belt 32 and the small gap G2 is formed downstream therefrom.

The length of the nip N1 is determined considering an elastic modulus and a pressure force of the charging roller 71, deflection of the endless belt 32, and so forth. Each size of the small gaps G1 and G2 is determined considering a voltage applied from the charging power source 35 to the charging roller 71, a thickness and dielectric constant of the endless belt 32.

The length of a basic charging region H1 is determined based on the length of the nip N1 formed between the outer face 71a of the charging roller 71 and the endless belt 32 and the distances of the small gaps G1 and G2 across which electric discharge occurs. The length of the basic charging region H1 is smaller than the length of the unit charging region W of the endless belt 32 to which an electric charge having a single polarity (e.g., a positive charge or a negative charge) in the belt rotation direction D1 of the endless belt 32.

Specifically, as shown in FIG. 16, the diameter DM of the charging roller 71 is smaller than the length of the unit charging region W. When the period of a sine wave of a voltage applied from the charging power source 35 to the charging roller 71 is defined as a full charging pitch P0, the diameter DM of the charging roller 71 is smaller than the half charging pitch P1 of the full charging pitch P0. Accordingly, the basic charging region H1 is smaller than the unit charging region W.

According to the sheet feeding unit 16A in Example Embodiment 2, the outer surface 71a of the charging roller 71 rotatably contacts the endless belt 32 to form the nip N1 having a predetermined distance therebetween, and electric discharge occurs to generate electric charge 72 at the small gap G formed at a position upstream from the nip N1 in the belt rotation direction D1 and electric charge 73 at the small gap G2 formed at a position downstream from the nip N1 in the belt rotation direction D1 to electrically charge the outer layer 32a of the endless belt 32. In Example Embodiment 2, the diameter DM of the charging roller 71 is smaller than the length of the unit charging region W and smaller than the half charging pitch P1 of the alternating charge that is applied from the charging roller 71 to the endless belt 32. This can attain a configuration in which the length of the basic charging region H1 determined based on the length of the nip N1 and the distances of the small gaps G1 and G2 is smaller than the unit charging region W having an identical charge polarity to the endless belt 32 in the belt rotation direction D1.

According to Example Embodiment 2, when the alternating voltage is applied to the charging roller 71, this configuration of the sheet feeding unit 16A can prevent movement of the electric charges 72 and/or 73 on the endless belt 32 over the nip N1 formed between the charging roller 71 and the endless belt 32 and inhibit immigration of the electric charges 72 and/or 73 having a polarity opposite a predetermined polarity to the endless belt 32. In addition, even if the electric charge 73 having a polarity opposite the polarity of the electric charge on the endless belt 32 is generated at the small gap G2 downstream from the nip N formed between the charging roller 71 and the endless belt 32 in the belt rotation direction D1 of the endless belt 32, the entire unit charging regions W of the endless belt 32 can maintain the normal charging state without being adversely affected by the movement of the electric charge(s) 72 and/or 73 and immigration of the electric charge(s) having an opposite polarity to the predetermined polarity.

As a result, the outer layer 32a of the endless belt 32 can be charged with the alternating charge, which is an alternating combination of the positive charge and the negative charge, at smaller pitches to cause the endless belt 32 to generate a sufficient force of attraction for attracting the uppermost sheet S1.

With this configuration, the sheet feeding unit 16A can quickly increase the force of attraction for attracting the uppermost sheet S1 of the stack of sheets loaded in the sheet container 15 to the endless belt 32 and can quickly decrease the force of attraction for attracting a subsequent sheet S2 and any other subsequent sheets to the endless belt 32. Accordingly, the time required for separating the sheets from the endless belt 32 can be decreased for better productivity of separation of the uppermost sheet S1.

Consequently, the sheet feeding unit 16A can perform feeding operations stably with various types of sheets S loaded in the sheet container 15 even when the environmental condition changes over time and can be highly reliable in separating and feeding sheets S one by one in a fast and robust manner.

The sheet feeding unit 16A can further include a cleaning unit to clean the endless belt 32 by removing paper dust and other foreign materials for preventing negative effects to the operation for attracting the sheets performed by the sheet feeding unit 16A.

The above-described exemplary embodiments are illustrative, and numerous additional modifications and variations are possible in light of the above teachings. For example, elements and/or features of different illustrative and exemplary embodiments herein may be combined with each other and/or substituted for each other within the scope of this disclosure. It is therefore to be understood that, the disclosure of this patent specification may be practiced otherwise than as specifically described herein.

Obviously, numerous modifications and variations of the present patent application are possible in light of the above teachings. It is therefore to be understood that, the invention may be practiced otherwise than as specifically described herein.

What is claimed is:

1. A sheet feeding unit, comprising:
an endless belt of multilayer construction including an outer layer formed of a dielectric material; and
a charging member including an electrode disposed in angled contact with the endless belt to charge the outer layer of the endless belt with an alternating voltage,
the charging member generating a force of attraction and the endless belt attracting an uppermost sheet placed on top of multiple sheets accommodated in a sheet container to separate the uppermost sheet from the multiple sheets and feed the uppermost sheet in a sheet conveyance direction,
the charging member electrode contacting the outer layer of the endless belt between which a nip having a predetermined length is formed,
an interior surface of the charging member and the endless belt defining a space across which electric discharge is performed to charge the outer layer of the endless belt,
a size of the space and the predetermined length of the nip in the sheet conveyance direction defining a basic charging region,
a length of the basic charging region in the sheet conveyance direction being smaller than a length of a unit charging region in which an electric charge of either positive polarity or negative polarity is held on the outer layer of the endless belt in a direction of rotation of the endless belt.

2. The sheet feeding unit according to claim 1, wherein the length of the basic charging region is smaller than one half of a cycle of a waveform of the alternating voltage applied from the charging member to the endless belt.

3. The sheet feeding unit according to claim 1, wherein the charging member includes a charging roller having a diameter smaller than the length of the unit charging region.

4. The sheet feeding unit according to claim 3, wherein the diameter of the charging roller is smaller than one half of a cycle of a waveform of the alternating voltage applied from the charging roller to the endless belt.

5. An image forming apparatus, comprising:
a sheet container to contain multiple sheets therein, the multiple sheets including an uppermost sheet placed on top thereof; and
a sheet feeding unit comprising:
an endless belt of multilayer construction including an outer layer formed of a dielectric material; and
a charging member including an electrode disposed in angled contact with the endless belt to charge the outer layer of the endless belt with an alternating voltage,
the charging member generating a force of attraction and the endless belt attracting the uppermost sheet to separate the uppermost sheet from the multiple sheets and feed the uppermost sheet in a sheet conveyance direction,
the charging member electrode contacting the outer layer of the endless belt between which a nip having a predetermined length is formed,
an interior surface of the charging member and the endless belt defining a space across which electric discharge is performed to charge the outer layer of the endless belt,
a size of the space and the predetermined length of the nip in the sheet conveyance direction defining a basic charging region,
a length of the basic charging region in the sheet conveyance direction being smaller than a distance of a unit charging region in which electric charges of identical polarity are held on the outer layer of the endless belt in a direction of rotation of the endless belt.
